(19) United States
(12) Patent Application Publication
(10) Pub. No.: US 2018/0310085 A1
(43) Pub. Date: Oct. 25, 2018

(54) Armature Speaker with Improved Rear Structure

(71) Applicant: EM-TECH. Co., Ltd., Busan (KR)

(72) Inventor: Jung Ho Kang, Gyeongsangnam-do (KR)

(21) Appl. No.: 15/956,475

(22) Filed: Apr. 18, 2018

(30) Foreign Application Priority Data
Apr. 20, 2017 (KR) 10-2017-0051168

(51) Int. Cl. H04R 1/02; H04R 9/04; H04R 7/04; H04R 1/10

(52) U.S. Cl. CPC H04R 1/025; H04R 9/045; H04R 1/1066; H04R 7/04; H04R 1/023

(57) ABSTRACT

The present disclosure provides an armature speaker that includes: a housing; a bobbin installed in the housing; a coil wound around the bobbin and configured to generate a magnetic field by current; a magnetic circuit installed in the housing and having an air gap; an armature having one end inserted into the air gap of the magnetic circuit and the bobbin, the armature configured to be magnetized by the magnetic field of the coil to interact with the magnetic circuit; a rod vertically connected to the armature; a diaphragm vibrated by the rod; a pair of terminals coupled to the bobbin such that the coil is electrically connected thereto, extended to the outside of the housing and directly electrically connected to an external substrate; and a back hole formed in the housing and positioned between the pair of terminals.

### PRIORITY CLAIM

The present application claims priority to Korean Patent Application No. 10-2017-0051168 filed on 20 Apr. 2017, the content of said application incorporated herein by reference in its entirety.

### TECHNICAL FIELD

The present invention relates to a rear structure of an armature speaker.

### BACKGROUND

As compared with a dynamic speaker, a speaker using a balanced armature can be decreased in size while maintaining high performance, and thus can be generally used for hearing aids.

Korea Patent 1504019 discloses a conventional armature speaker. Referring to FIG. 1 and Korea Patent 1504019, the armature speaker includes a housing on which a PCB 2 is mounted and inner components disposed inside the housing.

The inner components include a coil 5 wound to receive AC current, an armature 10 at least partially disposed in the coil 5 as a vibrator, a magnet 15 spaced apart from the armature 10, and a diaphragm 20 that receives vibration through a drive rod 7 bonded to the armature 10 and generates sound. The coil 5 is electrically connected and operated by the PCB 2. An opening part shown at the top left end of FIG. 1 emits the sound reproduced through the diaphragm 20. Due to the sound signal in the AC electricity state applied to the coil 5, the armature 10 itself, which is partially included in the coil 5, has magnetism. The armature 10 becomes an electromagnet having a property of a magnet when current flows, and the armature 10 placed between the magnets 15 alternates between N and S poles under the influence of the coil 5, and the armature 10 oscillates up and down under the influence of the magnetic field from the magnet 15 and thus generates vibration.

However, the conventional armature speaker has a disadvantage in that the air cannot smoothly flow into and out of the speaker, since a separate vent hole is not provided on the opposite side (rear side) to a sound-emitting hole (front side), which leads to reduced performance.

There is an armature speaker having a vent hole in the bottom surface or side surfaces, not the rear surface. However, generally, an earphone using an armature speaker employs a structure in which the speaker is inserted into a gasket and then inserted into an earphone case, as a result of which the gasket and the earphone case also need a vent hole. Moreover, in assembly, the vent holes of the gasket and the earphone should match with the vent hole of the armature speaker. There are thus disadvantages in that such directivity in assembly increases the assembly time and such a structure is vulnerable to external shocks.

Referring to U.S. Laid-Open Patent Publication No. 2016/0255433 and FIG. 2, disclosed is an armature speaker having two spouts 5504A and 5504B in a housing 5502. Here, the outward spout 5504B transfers or emits an amplified sound wave generated by an occlusion effect from an ear kernel of a user to the surrounding environment, However, in the armature speaker disclosed in the U.S. Laid-Open Patent Publication, the spout 5504B and a terminal 5518 should be formed at the rear side at the same time, as a result of which there is a limitation in the size of the spout 5504B. There is also a disadvantage in that the presence of the spout 5504B complicates the electric connection of the terminal 5518.

### SUMMARY

An object of the present invention is to provide an armature speaker with an improved rear structure that can improve a low frequency band sound level by forming a vent hole at the rear side.

Another object of the present invention is to provide an armature speaker with an improved rear structure that can eliminate a PCB by forming a terminal on a bobbin, which aids in installing a coil, and directly connecting a circuit to the terminal.

According to an aspect of the present invention for achieving the above objects, there is provided an armature speaker with an improved rear structure, comprising; a housing; a bobbin installed in the housing; a coil wound around the bobbin to generate a magnetic field by current; a magnetic circuit installed in the housing and having an air gap; an armature having one end inserted into the air gap of the magnetic circuit and the bobbin, the armature being magnetized by the magnetic field of the coil to interact with the magnetic circuit; a rod vertically connected to the armature; a diaphragm vibrated by the rod; a pair of terminals coupled to the bobbin such that the coil is electrically connected thereto, extended to the outside of the housing and directly electrically connected to an external substrate; and a back hole formed in the housing and positioned between the pair of terminals.

In some embodiments, the size of the back hole may be adjusted to control the volume of the air flowing in and out through the back hole.

In some embodiments, the armature speaker may further include a mesh screen for preventing foreign matters from entering through the back hole.

In some embodiments, the sieve size of the mesh screen may be adjusted to control the volume of the air flowing in and out through the back hole.

In some embodiments, the mesh screen may be made of a water-repellent mesh.

The armature speaker with the improved rear structure provided by the present invention has an advantage in that the conventional PCB installation space can be used for the rear vent hole, i.e., the back hole, by directly soldering the external circuit to the terminal fixed to the bobbin, instead of installing the PCB in the rear space.

In addition, the armature speaker with the improved rear structure provided by the present invention has an advantage in that the low frequency band sound pressure level can be adjusted merely by changing the size of the back hole, without changing the design of the inner components of the housing.

Further, the armature speaker with the improved rear structure provided by the present invention has an advantage in that the low frequency band sound pressure level can be adjusted merely by changing the sieve size (mesh number) of the mesh screen covering the back hole, without changing the design of the inner components of the housing.

Furthermore, the armature speaker with the improved rear structure provided by the present invention has an advantage in that the assembly time can be reduced by forming the back hole at the rear side which is not surround by the gasket or the like so that there is no directivity of the earphone case, hearing aid, or the like in assembly, and that falling safety can be secured by employing the structure in which the gasket surrounds the whole armature speaker.

Those skilled in the art will recognize additional features and advantages upon reading the following detailed description, and upon viewing the accompanying drawings.

### BRIEF DESCRIPTION OF THE DRAWINGS

FIG. 1 shows one example of a conventional armature speaker.

FIG. 2 shows another example of the conventional armature speaker.

FIG. 3 is a sectional view showing an armature speaker according to an embodiment of the present invention.

FIG. 4 is an exploded view showing the armature speaker according to the embodiment of the present invention.

FIG. 5 is a perspective view showing the armature speaker according to the embodiment of the present invention.

FIG. 6 is a graph showing a sound pressure level by frequencies of the armature speaker depending on the presence/absence of a back hole.

FIG. 7 is a graph showing a sound pressure level by frequencies depending on the changes in a mesh screen for covering a back hole.

FIG. 8 is a graph showing the THD by frequencies depending on the changes in a mesh screen for covering a back hole.

FIG. 9 is a view showing a state in which the armature speaker with the improved rear structure according to the embodiment of the present invention is installed in an earphone case.

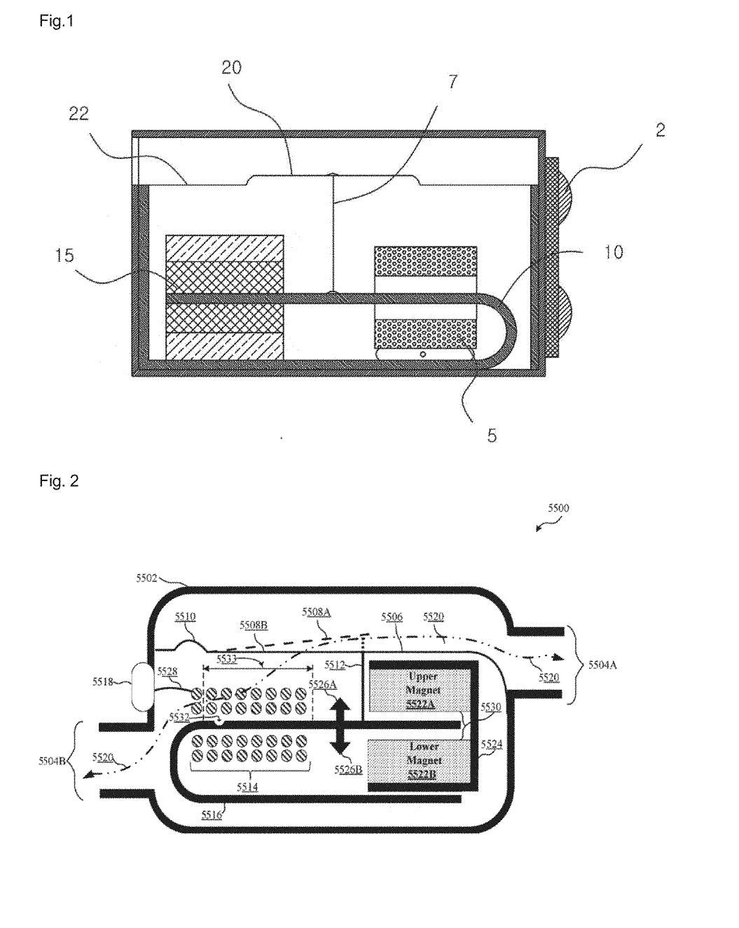

### DETAILED DESCRIPTION

Hereinafter, a preferred embodiment of an armature speaker with an improved rear structure according to the present invention will be described in detail with reference to the accompanying drawings.

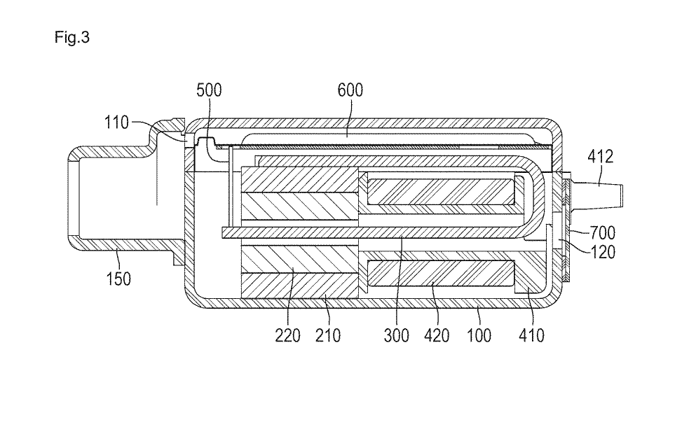

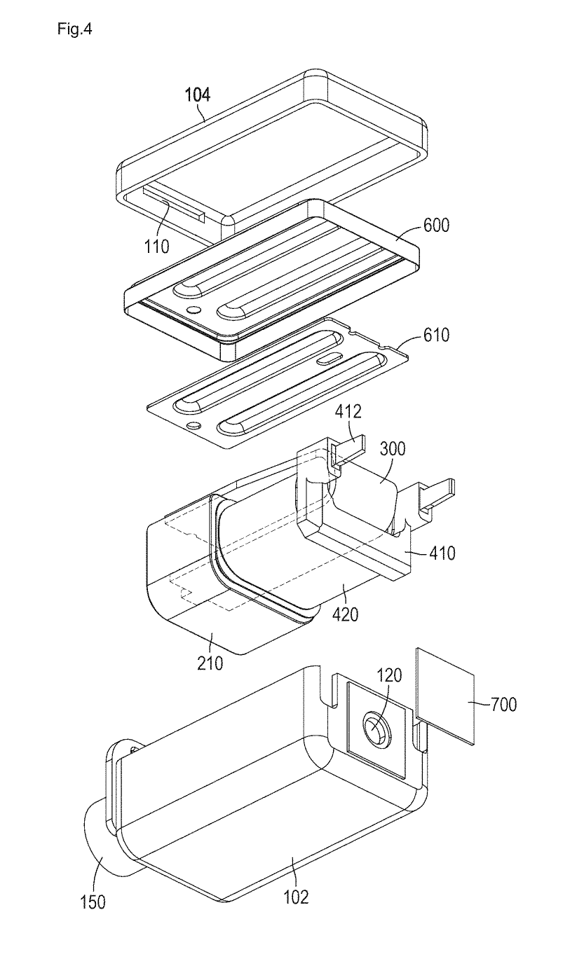

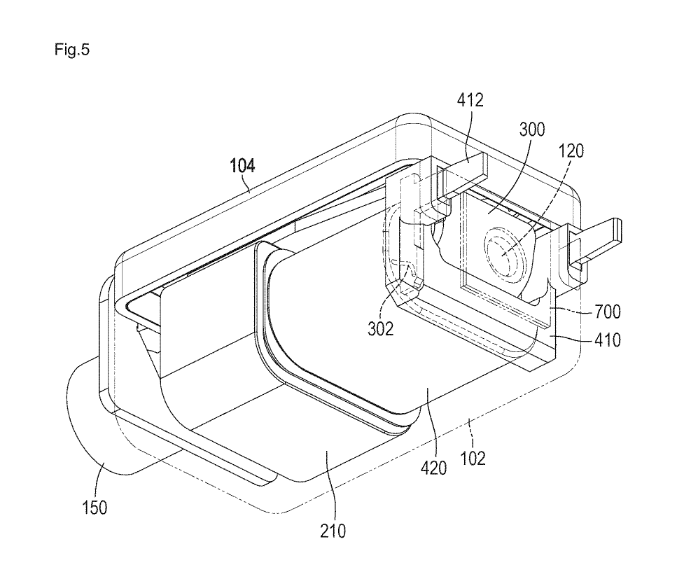

FIG. 3 is a sectional view showing an armature speaker according to an embodiment of the present invention, FIG. 4 is an exploded view showing the armature speaker according to the embodiment of the present invention, and FIG. 5 is a perspective view showing the armature speaker according to the embodiment of the present invention.

The armature speaker with the improved rear structure according to the present invention includes a housing 100, a bobbin 410 installed in the housing 100, a coil 420 wound around the bobbin 410 to generate a magnetic field by current, a magnetic circuit 210 and 220 installed in the housing 100 and having an air gap, an armature 300 having one end inserted into the air gap of the magnetic circuit 210 and 220 and the bobbin 410, the armature 300 being magnetized by the magnetic field of the coil 420 to interact with the magnetic circuit, a rod 500 vertically connected to the armature 300, a diaphragm 600 and 610 vibrated by the rod 500, a pair of terminals 412 coupled to the bobbin 410 such that the coil 420 is electrically connected thereto, the pair of terminals 412 being extended to the outside of the housing 100 and directly electrically connected to an external substrate, and a back hole 120 formed in the housing and positioned between the pair of terminals.

The housing 100 preferably includes a lower housing 102 and an upper housing 104 separately manufactured and coupled to each other, which makes it easier to install components in the housing 100. A sound-emitting hole 110 for emitting sound is formed in the upper housing 104, and a spout 150 attached after the coupling of the upper housing 104 and the lower housing 102 can guide the sound to be emitted to the sound-emitting hole 110.

For convenience, the spout 150 side that emits sound is referred to as a front side and the opposite side is referred to as a rear side.

The magnetic circuit 210 and 220 is installed in front of the bobbin 410 in the housing 100. The magnetic circuit 210 and 220 includes a hollow yoke 210 and a pair of permanent magnets 220 installed in the yoke 210. The pair of permanent magnets 220 are placed up and down with a gap therebetween. One end of the armature 300 is inserted into the gap between the permanent magnets 220, i.e., the air gap. Although the magnetic circuit 210 and 220 is illustrated as having the yoke 210 and the pair of permanent magnets 220, the air gap may be defined by one permanent magnet 220 or the yoke 210 may be eliminated.

The armature 300, which is formed in a U-shape, has one end positioned outside the bobbin 410, the coil 420 and the magnetic circuit 210 and 220 and the other end inserted into the bobbin 410, the coil 420 and the magnetic circuit 210 and 220. When current flows through the coil 420, the armature 300 is magnetized, and thus is made to vibrate due to the mutual electromagnetic force with the permanent magnets 220, The end of the armature 300 is more extended to the front side than the magnetic circuit 210 and 220, and the rod 500 is vertically connected to that extended end.

The lower end of the rod 500 is connected to the armature 300, and the upper end of the rod 500 is connected to the diaphragm 600 and 610, such that, during the vibration of the armature 300, the diaphragm 600 and 610 is also vibrated by the rod 500. The diaphragm 600 and 610 is a combined form of a TPU-based film diaphragm 600 and a metal diaphragm 610, and the metal diaphragm 610 is preferably made of aluminum.

The pair of terminals 412 coupled to the bobbin 410 through a hole formed at the rear side of the housing 100 are extended and exposed. The bobbin 410 is generally an LOP-based injection plastic, and the terminals 412 are made of a metal with electric conductivity and insert-molded during the injection manufacturing of the bobbin 410. Only the terminals 412 may be exposed through the rear side of the housing 100, but part of the bobbin 410 injection product that surrounds the terminals 412 may also be exposed to protect the terminals 412. One end of the terminal 412 is positioned inside the housing 100 and the other end thereof is positioned outside the housing 100. A lead wire 302 of the coil 300 is soldered to one end positioned inside the housing 100, and an external circuit for controlling the armature speaker is directly soldered to the other end positioned outside the housing 100. The pair of terminals 412 are placed at right and left sides with a gap therebetween at the rear side of the housing 100, and the back hole 102 may be formed in this gap.

The back hole 120 is formed at the rear side of the housing 100 for ventilation purposes. The back hole 120 is formed between the pair of terminals 412 as explained above. Since the external circuit is directly soldered to the terminals 412 and the PCB is eliminated, a separate installation space for the PCB is not required near the terminals 412, and thus a sufficient installation space for the back hole 120 can be secured.

Here, it is possible to control the low frequency band sound pressure level simply by adjusting the size of the back hole 120 of the housing 100, without changing the design of the inner components of the armature speaker.

Meanwhile, a mesh screen 700 for blocking the back hole 120 may be further installed to prevent foreign matters from entering through the back hole 120. It is possible to control the volume of the air flowing in and out through the back hole 120 of the same size by adjusting the sieve size of the mesh screen 700, i.e., the mesh number, and thus possible to finely tune a sound pressure level in a low frequency band range of 200 Hz to 2 kHz.

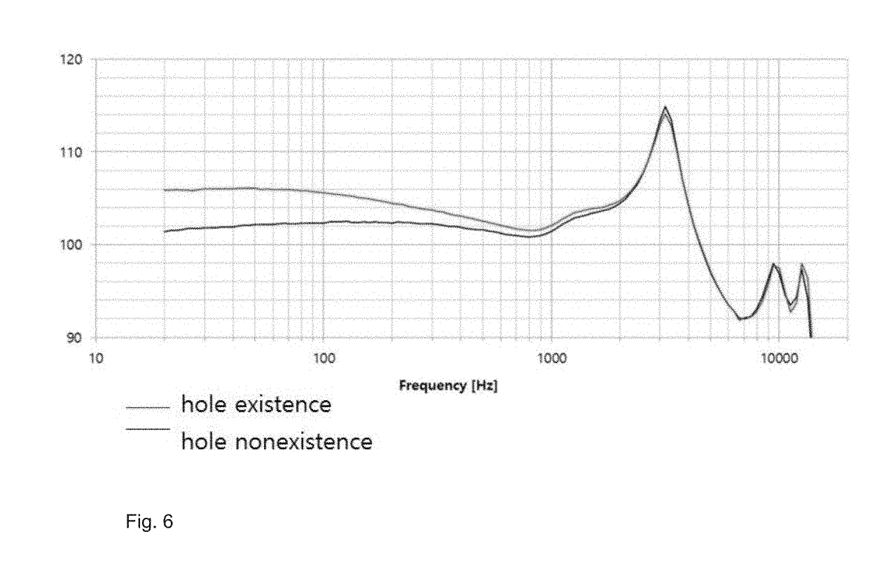

FIG. 6 is a graph showing a sound pressure level by frequencies of the armature speaker depending on the presence/absence of the back hole. As can be seen in FIG. 6, in a low frequency band range of 20 Hz to 500 Hz, the sound pressure level rises up to 4.4 dB at the presence of the back hole.

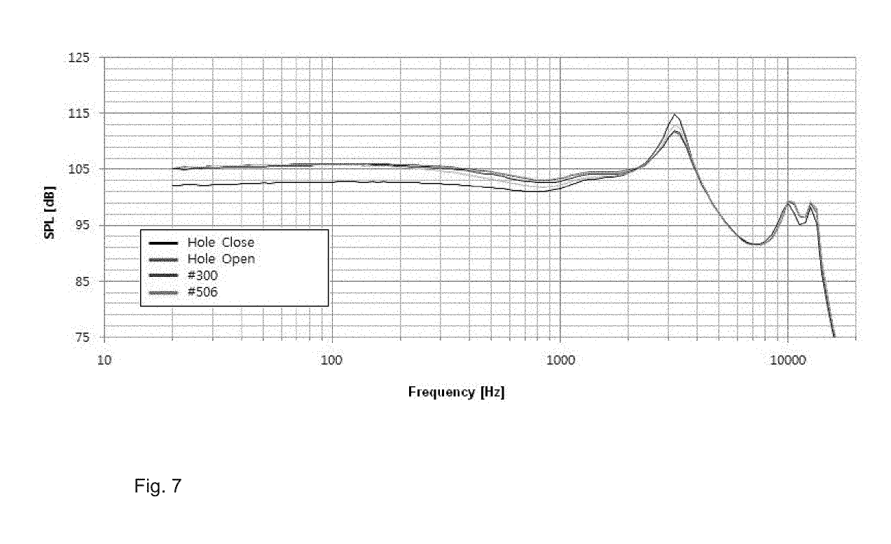

FIG. 7 is a graph showing a sound pressure level by frequencies depending on the changes in the mesh screen for covering the back hole. As can be seen in FIG. 7, the larger the mesh number is, i.e., the smaller the sieve size is, in a low mid-frequency band range of 200 Hz to 1 kHz, the sound pressure level decreases up to 1 dB.

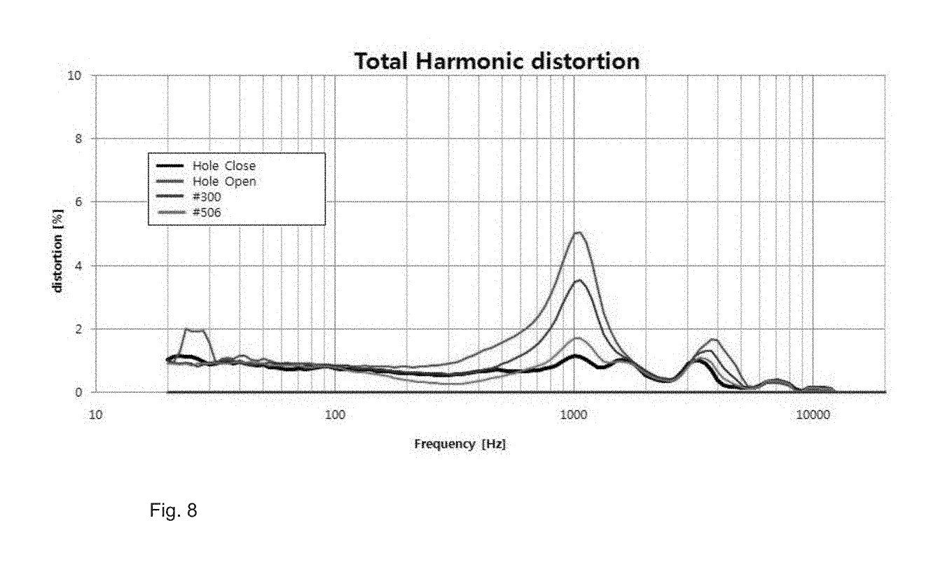

FIG. 8 is a graph showing the THD by frequencies depending on the changes in the mesh screen for covering the back hole. It can be seen that the larger the mesh number is, i.e., the smaller the sieve size is, the THD decreases near 1 kHz.

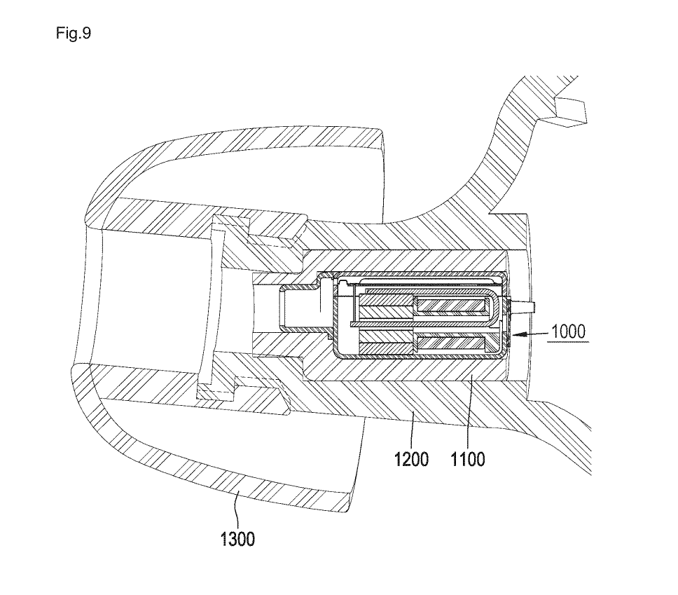

FIG. 9 is a view showing a state in which the armature speaker with the improved rear structure according to the embodiment of the present invention is installed in an earphone case. A gasket 1100 made of rubber is interposed between the armature speaker 1000 and the earphone case 1200 to protect the speaker 1100 from external shocks. An ear tip 1300 or the like is installed on the earphone case 1200 to help a user wearing an earphone. The sound generated by the armature speaker is finally transferred to the user's ear through the sound-emitting hole (110; see FIG. 3) of the armature speaker, the spout (150; see FIG. 3), a sound path formed in the gasket 1100, a sound path formed in the earphone case 1200, and a sound path formed in the ear tip 1300.

As discussed earlier, since the back hole (120; see FIG. 3) of the armature speaker 1000 is formed at the rear side of the armature speaker 1000, a vent hole is not required in the side surface or the bottom surface thereof, and thus an additional vent hole is not required in the gasket 1100 and the earphone case 1200. Therefore, the assembly time can be reduced because there is no directivity of the gasket 1100 and the earphone case 1200 in assembly. In addition, since the gasket 1100 surrounds the whole armature speaker 1000, reliability against external shocks can be secured.

With the above range of variations and applications in mind, it should be understood that the present invention is not limited by the foregoing description, nor is it limited by the accompanying drawings. Instead, the present invention is limited only by the following claims and their legal equivalents.

What is claimed is:

1. An armature speaker, comprising:
a housing;
a bobbin installed in the housing;
a coil wound around the bobbin and configured to generate a magnetic field by current;
a magnetic circuit installed in the housing and having an air gap;
an armature having one end inserted into the air gap of the magnetic circuit and the bobbin, the armature configured to be magnetized by the magnetic field of the coil to interact with the magnetic circuit;
a rod vertically connected to the armature;
a diaphragm vibrated by the rod;
a pair of terminals coupled to the bobbin such that the coil is electrically connected thereto, extended to the outside of the housing and directly electrically connected to an external substrate; and
a back hole formed in the housing and positioned between the pair of terminals.

2. The armature speaker of claim 1, wherein a size of the back hole is adjustable to control a volume of air flowing in and out through the back hole.

3. The armature speaker of claim 1, further comprising a mesh screen configured to prevent foreign matters from entering through the back hole.

4. The armature speaker of claim 3, wherein a sieve size of the mesh screen is adjustable to control a volume of the air flowing in and out through the back hole,

5. The armature speaker of claim 3, wherein the mesh screen is made of a water-repellent mesh.

6. A method of manufacturing an armature speaker, the method comprising:
installing a bobbin in a housing;
winding a coil around the bobbin, the coil configured to generate a magnetic field by current;
installing a magnetic circuit in the housing, the magnetic circuit having an air gap;
inserting one end of an armature into the air gap of the magnetic circuit and the bobbin, the armature configured to be magnetized by the magnetic field of the coil to interact with the magnetic circuit;
vertically connecting a rod to the armature;
installing a diaphragm vibrated by the rod;
coupling a pair of terminals to the bobbin such that the coil is electrically connected thereto, extended to the outside of the housing and directly electrically connected to an external substrate; and
forming a back hole in the housing and positioned between the pair of terminals.

7. The method of claim 6, further comprising adjusting a size of the back hole to control a volume of air flowing in and out through the back hole.

8. The method of claim 6, further comprising installing a mesh screen configured to prevent foreign matters from entering through the back hole.

9. The method of claim 8, further comprising adjusting a sieve size of the mesh screen to control a volume of the air flowing in and out through the back hole.

10. The method of claim 8, wherein the mesh screen is made of a water-repellent mesh.
